(19) United States
(12) Patent Application Publication
(10) Pub. No.: US 2012/0139207 A1
(43) Pub. Date: Jun. 7, 2012

(54) ADJUSTABLE SEAT POST FOR BICYCLE

(75) Inventor: Diogo Porto Ferreira, Taichung County (TW)

(73) Assignee: TIEN HSIN INDUSTRIES CO., LTD., Wufeng Township (TW)

(21) Appl. No.: 12/958,667

(22) Filed: Dec. 2, 2010

(51) Int. Cl. B62J 1/04

(52) U.S. Cl. 280/287

(57) ABSTRACT

An adjustable seat post is composed of a seat post, a slide member, a locker assembly, and a clamp assembly. The seat post includes a tube and a guide base mounted to a top end of the tube. The slide member is linearly movably mounted on the guide base and includes a through hole running through a top side thereof and a bottom side thereof. The locker assembly includes a locking piece and a linking bar. The locking piece is rotatably mounted in the guide base. The linking bar has a first end movably connected with the locking piece, and a second end pivoted to the slide member and located in the through hole. The clamp assembly is mounted onto the slide member for holding a saddle. In this way, the slide member can be firmly mounted to the guide base.

### BACKGROUND OF THE INVENTION

1. Field of the Invention

The present invention relates generally to a bicycle, and more particularly, to an adjustable seat post for a bicycle.

2. Description of the Related Art

As cycling has become one of popular leisure sports, the comfortableness is more and more noted. Under different scenarios, a cyclist has different riding positions. For example, when a bicycle runs at high speed or for a long distance, the cyclist mostly leans his or her upper torso forward to reduce wind resistance and burden to the cyclist. For the cyclist's convenience and comfortableness in adjustment of riding position, a bicycle saddle capable of adjusting the anteroposterior position or angle of the saddle. A conventional bicycle post assembly is composed of a seat post, an adjustment set, and a clamp set. The adjustment set includes a guide base mounted on the seat post, and a slide member mounted on the guide base. The slide member having two guide bolts. inserted into a predetermined portion of the slide member The guide bolts extending into a guide portion of the guide base. Each of the guide bolts has a distal end threaded with a locking member slidable mounted in the guide portion. In this way, the slide member is diametrically movable on the guide base. The clamp set is mounted on the slide member, diametrically movable along with the guide member, and can finely hold a lower strut of the saddle. In light of the above structure, the anteroposterior of the saddle can be adjusted.

However, after used for a long time, the lockout between the slide member and the guide base is inevitably subject to disengagement. Because the locking member is freely slidable in the guide portion, once the guide bolts disengage from the locking member as the cyclist rides the bicycle, the slide member can be seriously deviated with respect to the guide base under the cyclist's weight and the force generated while the bicycle is accelerated. Under the circumstances, the structure at this point is subject to damage to endanger the cyclist.

### SUMMARY OF THE INVENTION

The primary objective of the present invention is to provide an adjustable seat post, which can improve the drawback of the prior art mentioned above.

The foregoing objective of the present invention is attained by the adjustable seat post composed of a seat post, a slide member, a locker assembly, and a clamp assembly. The seat post includes a tube and a guide base mounted to a top end of the tube. The slide member is linearly movably mounted on the guide base and includes a through hole running through a top side thereof and a bottom side thereof. The locker assembly includes a locking piece and a linking bar. The locking piece is rotatably mounted in the guide base. The linking bar has a first end movably connected with the locking piece, and a second end pivoted to the slide member and located in the through hole. The clamp assembly is mounted onto the slide member for holding a saddle. In this way, the slide member can be firmly mounted to the guide base.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a sectional view taken along a line 3-3 indicated in FIG. 1.

FIG. 4 is a sectional view taken along a line 4-4 indicated in FIG. 1.

FIG. 5 is a schematic view of the preferred embodiment of the present invention, illustrating that the saddle is linearly moved.

FIG. 6 is another schematic view of the preferred embodiment of the present invention, illustrating that angle of the saddle is changed.

### DETAILED DESCRIPTION OF PREFERRED EMBODIMENTS

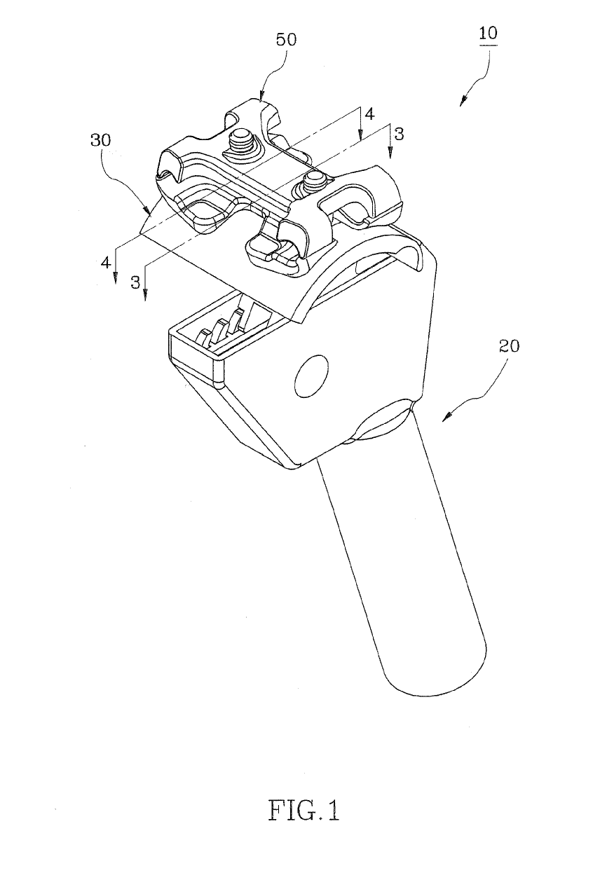

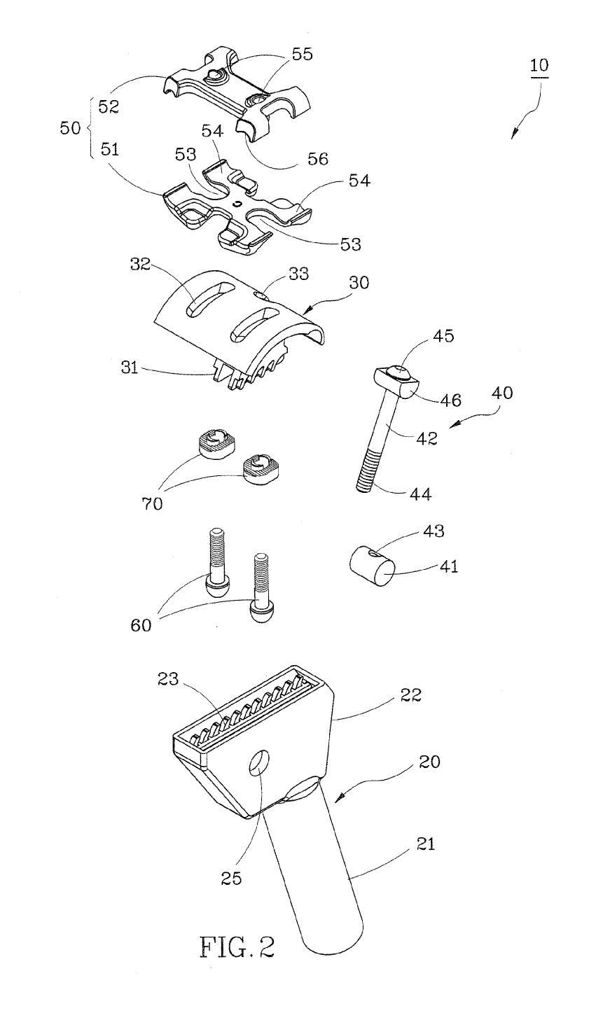

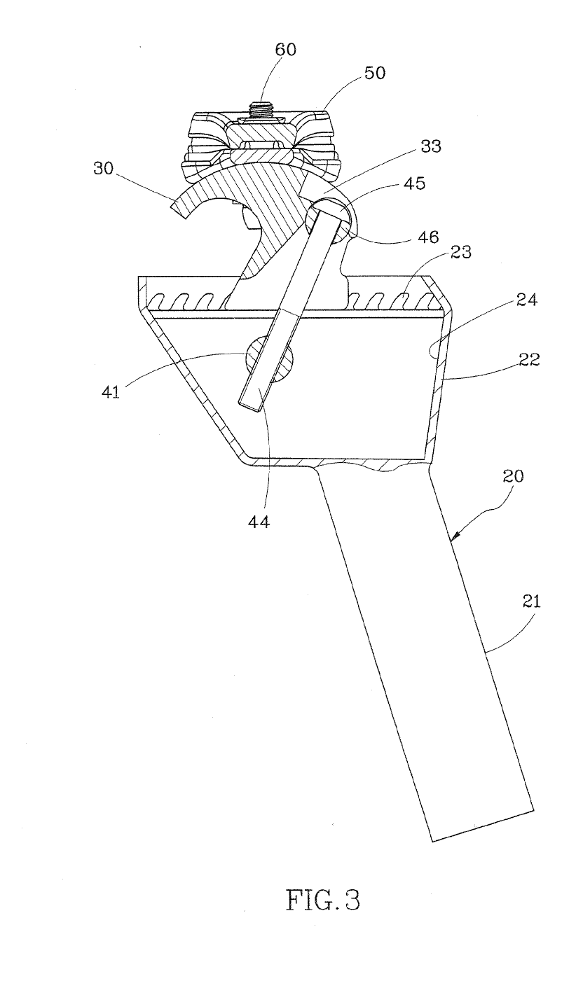

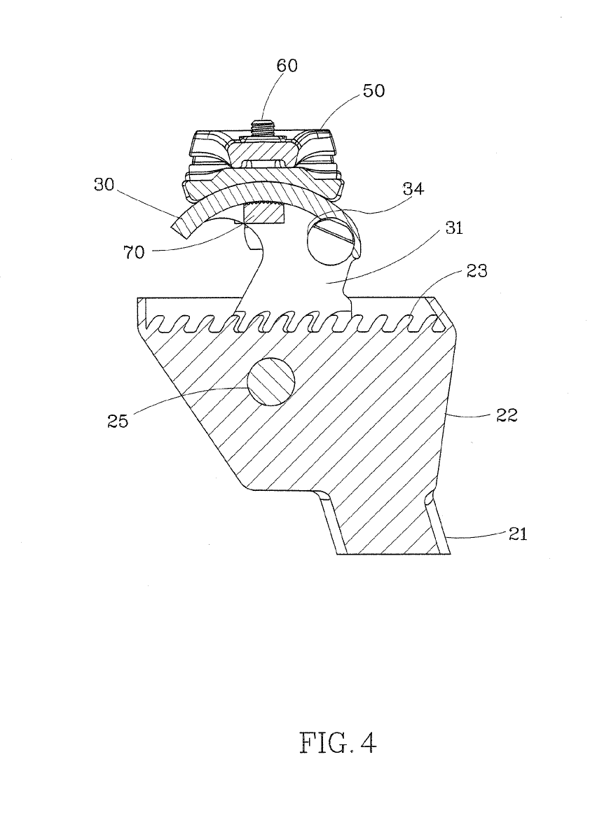

Referring to FIGS. 1-4, an adjustable seat post 10 for a bicycle in accordance with a preferred embodiment of the present invention is composed of a seat post 20, a slide member 30, a locker assembly 40, a clamp assembly 50, two fasteners 60, and two washers 70. The detailed descriptions and operations of these elements as well as their interrelationships are recited in the respective paragraphs as follows.

The seat post 20 includes a tube 21 and a guide base 22 mounted to a top end of the tube 21. The guide base 22 can be fixed to the top end of the tube 21 and has a first teeth portion 23 formed on a top side thereof, a chamber 24 formed therein, and two through holes 25 located on two opposite sides of the guide base 22 and communicating with the chamber 24 and the outside. The first teeth portion 23 is formed of two rows of serrations arranged at two respective sides of the top side of the guide base 22 and partially covering a top of the chamber 24 to form an elongated opening.

The slide member 30 is linearly movably mounted on the guide base 22 and includes a convex camber formed at a top side thereof, a concave camber formed on a bottom side thereof, a second teeth portion 31 extending outward from the bottom side thereof and engaging the first teeth portion 23, two slots 32 running through the top and bottom sides thereof and located at two sides of the second teeth portion 31, a through hole 33 running through the top and bottom sides thereof, and a cavity 34 located on a top side of the second teeth portion 31 and communicating with the through hole 33.

The locker assembly 40 includes a locking piece 41 and a linking bar 42. The locking piece 41 is cylindrical and has two ends inserted into the two through holes 25 of the guide base 22 separately in such a way that the locking piece 41 is rotatably mounted to the chamber 24. The locking piece 41 has a through hole 43 formed at a center thereof. The linking bar 42 having a first end 44 and a second end 45 and can be inserted into the through hole 33 to be threaded with the through hole 43 at the first end 44, such that the linking bar 42 can be axially moved along the through hole 43. Besides, a semi-cylindrical limiting piece 46 is further sleeved onto the second end 45 of the linking bar 42 to limit the second end 45 to the cavity 34. The locker assembly 40 can hold the slide member 30 onto the guide base 22.

The clamp assembly 50 is mounted to the slide member 30 and composed of a lower shell 51 and an upper shell 52. The lower shell 51 includes two lower pass-through portions 53 recessed inward from two opposite sides thereof and communicating with the two slots 32, and two lower ditches 54 formed at two opposite top sides thereof, The upper shell 52 has two upper pass-through portions 55 shaped as circular holes and communicating with the two lower pass-through portions 53 separately, and two upper ditches 56 formed on a bottom side of the upper shell 52 and corresponding to the two lower ditches 54, such that the lower and upper ditches 54 and 56 can hold two positioning bars of a saddle.

The two fasteners 60 are two screw bolts and inserted through the slots 32, the lower pass-through portions 53, and the upper pass-through portions 55 in turn to fasten the clamp assembly 50 to a top side of the slide member 30.

The two washers 70 are sleeved onto the two fasteners 60 separately and each include a serrated convex camber formed on a top side thereof and stopped against a bottom side of the slide member 30 for increasing the frictional force between the washers 70 and the bottom side of the slide member 30.

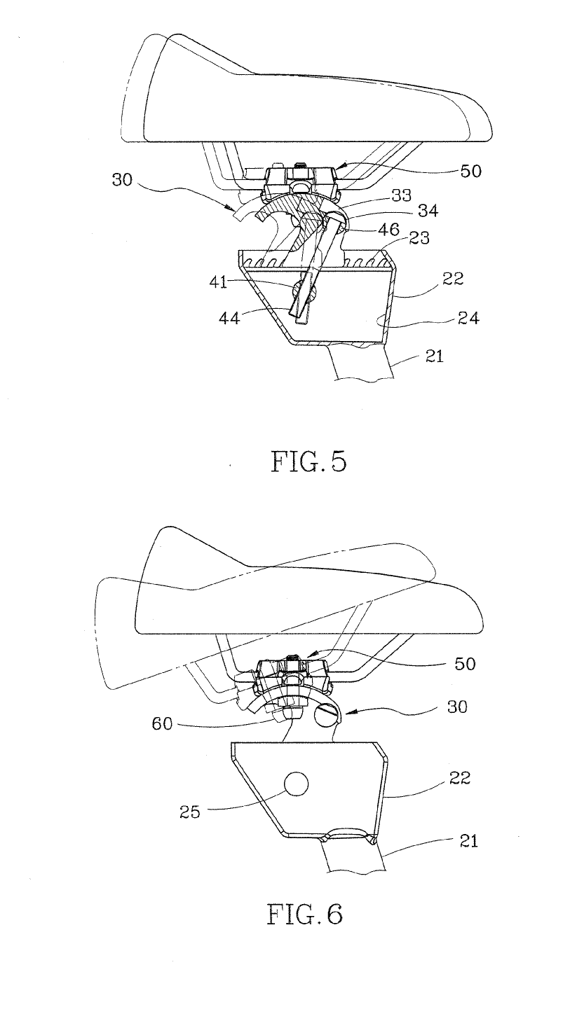

Referring to FIG. 5, when it is intended to adjust the anteroposterior position of the saddle, a user can screw off the linking bar 42 of the locker assembly 40 in such a way that an adjustable space is formed between the slide member 30 and the guide base 22, and then the user can raise and move the slide member 30 as well as the clamp assembly 50 and the saddle toward a predetermined position linearly. In the meantime, the linking bar 42 can be deviated for a predetermined angle on the locking piece 41 acted as a pivot and meanwhile drive rotation of the locking piece 41, and the limiting piece 46 can be rotated with respect to the cavity 34. When the slide member 30 reaches the predetermined position, the user can screw on the linking bar 42 to make the limiting piece 46 be tightly engaged with the cavity 34 to firmly fasten the slide member 30 to the guide base 22.

Referring to FIG. 6, when it is intended to adjust the inclination angle of the saddle, the user can screw off the fasteners 60 to generate a gap between the clamp assembly 50 and the slide member 30 and then slide the clamp assembly 50 together with the saddle along the top side of the slide member 30 subject to an required angle; meanwhile, the fasteners 60 are movable in the slots 32 separately. When the required angle is reached, the user can screw on the fasteners 60 to fasten the clamp assembly 50 to the slide member 30.

As can be seen from the above, the seat post 10 is linearly movably mounted to the guide base 22 and the guide base 22 includes sufficient space for the linear movement of the slide member 30 to allow more adjustable anteroposterior movement for the saddle. Besides, the slide member 30 and the guide member 22 engage with each other by the serrations thereof in such a way that the slide member 30 can be mounted to the guide base 22 more firmly.

It is to be noted that in light of the rotably locking piece 41 of the locker assembly 40, the limiting piece 46 can still be tightly engaged with the cavity 34, as the slide member 30 is variably located on the guide base 22, to enforce the firmness between the slide member 30 and the guide base 22 for more service life of the seat post 10. Even if the slide member 30 and the guide base 22 disengage from each other because the seat post 10 is operated for a long time, the locker assembly 40 can still prevent the structural damage resulting from the deviation of the saddle in the process of the user's cycling to further enhance the safety of the user riding the bicycle.

In addition, the present invention has the following interchangeable structures. The number of the slot 32 of the slide member 30 can be one or more. Correspondingly, so are the numbers of the lower and upper pass-through portions 53 and 55. Besides, the slide member 30 and the guide base 22 engage each other to allow the slide member 30 to be linearly moved on the guide base 22. Alternatively, the slide member 30 and the guide base 22 can have channels formed thereon for functioning as the same.

Last but not the least, the present invention though has been described with respect to a specific preferred embodiment thereof, but it is in no way limited to the specifics of the illustrated structures but changes and modifications may be made within the scope of the appended claims.

What is claimed is:

1. An adjustable seat post for a bicycle, comprising:
a seat post having a tube and a guide base mounted to a top end of the tube;
a slide member linearly movably mounted on the guide base and having a through hole running through a top side thereof and a bottom side thereof;
a locker assembly having a locking piece and a linking bar, the locking piece being rotatably mounted to the guide base, the linking bar having a first end movably connected with the locking piece and a second end pivoted to the slide member and located in the through hole; and
a clamp assembly mounted on the slide member for holding a saddle.

2. The adjustable seat post as defined in claim 1, wherein the guide base comprises a first teeth portion formed on a top side thereof, and the slide member comprises a second teeth portion formed on a bottom side thereof and engaging the first teeth portion.

3. The adjustable seat post as defined in claim 2, wherein the second teeth portion comprises a cavity formed on a top side thereof for engagement with a limiting piece sleeved onto the second end of the linking bar, the cavity communicating with the through hole of the slide member.

4. The adjustable seat post as defined in claim 1, wherein the slide member further comprises at least one slot running through the top and bottom sides thereof.

5. The adjustable seat post as defined in claim 4, wherein the clamp assembly further comprises a lower shell and an upper shell, the lower shell having at least one lower pass-through portion in communication with the at least one slot, the upper shell having at least one upper pass-through in communication with the at least one lower pass-through portion.

6. The adjustable seat post as defined in claim 5, wherein the lower shell comprises two lower ditches formed on a top side thereof and located at two opposite sides thereof, and two upper ditches formed on a bottom side thereof and corresponding to the two lower ditches respectively.

7. The adjustable seat post as defined in claim 5 further comprising at least one fastener passing through the at least one slot, the lower pass-through portion, and the upper pass-through portion in turn to fasten the clamp assembly to the top side of the slide member.

8. The adjustable seat post as defined in claim 7 further comprising at least one washer sleeved onto the at least one fastener and stopped against the bottom side of the slide member.

9. The adjustable seat post as defined in claim 8, wherein the slide member comprises a concave camber formed on a bottom side thereof and the washer comprises a serrated convex camber formed on a top side thereof and stopped against the bottom side of the slide member.

10. The adjustable seat post as defined in claim 1, wherein the locking piece is threaded with the first end of the linking bar.

11. The adjustable seat post as defined in claim 10, wherein the locking piece comprises a through hole threaded with the first end of the linking bar.

12. The adjustable seat post as defined in claim 1, wherein the slide member comprises a convex camber formed on the top side thereof for the clamp assembly to move with respect to the slide member for changing an inclination angle of the clamp assembly.

13. The adjustable seat post as defined in claim 1, wherein the guide base comprises a chamber and two through holes located at two opposite sides thereof respectively and communicating with the chamber and an outside; the locking piece comprises two ends located in the two through holes respectively.
